(19) United States
(12) Patent Application Publication
(10) Pub. No.: US 2021/0130086 A1
(43) Pub. Date: May 6, 2021

(54) RELATING TO, HEATING PADS FOR BULK CONTAINERS

(71) Applicant: Argus Heating Limited, Christchurch (NZ)

(72) Inventors: Andrew Craig Russell, Christchurch (NZ); Damien Chollet, Christchurch (NZ); Murray Taylor, Christchurch (NZ)

(21) Appl. No.: 16/604,993

(22) PCT Filed: Apr. 13, 2018
(86) PCT No.: PCT/NZ2018/050053

§ 371 Date: Oct. 11, 2019

(30) Foreign Application Priority Data
Apr. 13, 2017 (NZ) 731033

(51) Int. Cl. B65D 88/74; B65D 1/18; H05B 3/34

(52) U.S. Cl. CPC B65D 88/744; B65D 1/18; H05B 2203/017; H05B 2203/003; H05B 2203/014; H05B 3/34

(57) ABSTRACT

The invention is for a heating pad for a container to lie against at least one external surface of the container, and apply thermal energy to the container, and any material therein, when needed. The pad consists of a foamed resilient substrate with a first presenting major surface substantially equal in area to the at least one external surface of the container. A heating cable is located on the first presenting major surface to form an electrical circuit that when energised provides the thermal energy. A planar sheet material is above the first presenting major surface, and below a second presenting major surface of the substrate, the planar sheet material extends past the first and second presenting major surfaces and sealed at a periphery to form an encapsulation of the substrate and heating cable. There is an electrical connection from the heating cable internally of the encapsulation to external of the encapsulation. Such that the heating pad can be located against the at least one external surface of the container to move with that container, and when connected to a source of electricity can supply thermal energy to the container and any material contained therein.

### PRIORITY CLAIM

This application is a U.S. national phase of International Patent Application No. PCT/NZ2018/050053 filed Apr. 13, 2018; which claims the benefit of priority from New Zealand Patent Application No. 731033 filed Apr. 13, 2017, the contents of which are incorporated herein by reference in their entireties.

### FIELD OF THE INVENTION

The present invention relates to heating pads.

In particular, though not solely, the present invention is directed to heating pads or slip pads for Intermediate Bulk Containers (IBC) and the like.

### BACKGROUND OF THE INVENTION

When moving product in bulk there is often a need to heat that product, for example when the product is a solid, or near solid when at ambient temperature, to change the viscosity or phase of the product to a liquid to enable ease of decanting or removal from the container it is in. In addition there may simply be the desire the heat the product up to a desired temperature prior to using it, even if in a liquid state at ambient temperature.

There have been many solutions to date. The main area of these is to provide a heater on the exterior of the container. The main solution utilised is a heater pad or blanket, typically as a heater pad this sits underneath the container, often sandwiched between the container and the packing or transport pallet it is located on.

Sometimes the containers with the material in may sit for many months, or even years until needed. The content of the container may be $1,000 or $10,000 worth and is valuable. If the heater pad fails, either by not working to heat the material at all this is not desirable. This is because the container may weigh several tons and may not be robust enough to be lifted separately for the heater pad to be replaced. Further, if the heater pad overheats, for example by a short circuit, then it may locally overheat the product, resulting in a tainted or damaged product thus making that product unusable, at least for the intended purpose. It is worse still if the heater pad catches on fire and damages not only the product it is for, but also surrounding product and any facilities.

Therefore the heater pad must be reliable over many environments and time frames.

Heater pads to date have largely been in two forms, both using electrical energy converted to thermal energy using a heating cable. The heating cable is laid out in a flat shape of the desired size and is connectable to a source of electricity. The first form is a simple laminate of paper or similar either side of the heater cable circuit to hold the heater cable in the correct orientation. In some instances this paper is treated, such as with a silver foil to aid in the heat transfer process. This has the disadvantage of not being waterproof and so if in a moist environment the paper liner either side may deteriorate, or at least moisture or water may reach the heater cable. This may cause corrosion of the heating cable materials, or a short circuit when energised. Neither of these is desirable. Further such a light version of heater pad is not robust and may not protect the heater cable and its connection adequately over a long period of time or from general wear and tear, either in storage of the pad itself, transportation or when with its container in storage. Also such a construction is not foodsafe.

The second form has the heater cable circuit potted in a rubber compound, such as silicone rubber. This produces a food safe product. However, when employed on an IBC, which normally requires a 1 metre by 1 metre heater pad, such a construction is then very heavy and can weigh 12 kilograms or more. This creates handling issues of the pad by itself as it has little structural resiliency and flops and folds easily. This increases the likelihood of damage and failure of the heating function. A further disadvantage of such materials is that even when not heating, for example in storage by themselves, or with a container, they become sticky due to the nature of the potting material. This can be undesirable from a general look and feel of the pad, but may also introduce contaminants if anything adheres to the pad. If the pad needs then to be cleaned, either before use, or after use if being reused, this is a further undesirable step that introduces cost. This results in unnecessary wastage and cost. This may lead to further unreliability or failure, with consequent cost or damage as earlier described, and again is undesirable.

There are other forms of heater pad that are rigid and are referred to as metal in base heaters. These utilise a sheet metal substrate as the internal rigid base to which the heating cable is then located. These may be sealed also. However, these have the drawback of requiring electrical and or thermal insulation between the heating cable and the sheet metal substrate in case there is a short circuit. Also these are less resilient and can bend and break the heating cable, when they bend also they will stay bent. Bending them back to flat can prove difficult, if not impossible, and will weaken or break the metal sheet and or the heating cable, and any electrical and thermal insulation. Also such metal in base heaters are not very efficient as the metal in base acts as a thermal conductor and the thermal energy conducts and radiates from the sides as well as out the bottom. This is inefficient when trying to heat only a container placed on the upper surface of the heating pad.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

It is an object of the present invention to provide an improved heater pad, or to overcome the above shortcomings or address the above desiderata, or to at least provide the public with a useful choice.

### cl SUMMARY OF THE INVENTION

In a first aspect the present invention consists in a heating pad for a container to lie against at least one external surface of the container, and apply thermal energy to the container, and any material therein, when needed, comprising or including,
a foamed resilient substrate with a first presenting major surface substantially equal in area to the at least one external surface of the container,
   a heating cable located on the first presenting major surface to form an electrical circuit that when energised provides the thermal energy,
   a planar sheet material above the first presenting major surface, and below a second presenting major surface of the substrate, the planar sheet material extending past the first and second presenting major surfaces and sealed at a periphery to form an encapsulation of the substrate and heating cable,
   an electrical connection from the heating cable internally of the encapsulation to external of the encapsulation,
such that the heating pad can be located against the at least one external surface of the container to move with that container, and when connected to a source of electricity can supply thermal energy to the container and any material contained therein.

Preferably the resilient substrate is planar or curved to match the contour of the container.

Preferably the planar substrate has a pathway formed on the first presenting major surface as a recess into the planar substrate to receive the heating cable.

Preferably the pathway is the same shape as the path of the electrical circuit of the heating cable.

Preferably the pathway is a series of preformed connected radial or parallel grooves.

Preferably a thermal output of the heater wire is below a thermal capacity of the planar substrate and planar sheet material to prevent it from burning.

Preferably the planar substrate and planar sheet material have a thermal dissipation rate that is greater than the thermal output rate of the heating cable when energised.

Preferably the second presenting major surface is parallel to the first major presenting surface.

Preferably the electrical connection is at least in part an electrical flex.

Preferably the electrical connection passes through, at, or near the periphery.

Preferably the electrical connection is also physically connected to the planar substrate or planar sheet material such that it can also be used as a handle to manoeuvre at least the heating pad without pulling out from the heating pad or affecting the connection to the heating cable.

Preferably the seal at the periphery lies substantially between the first presenting major surface, and the second presenting major surface.

Preferably the seal is achieved by bonding, welding, or gluing the sheet material.

Preferably the sheet material is flexible.

Preferably the sheet material is a plastics coated woven material or a plastics material.

Preferably the heating pad can flex in and out of plane of the major surfaces without breaking.

Preferably the planar substrate can deform at least i part to contour to the underside of the container to improve transfer of the thermal energy.

Preferably the container is an intermediate bulk container (IBC), or drum.

Preferably the heating pad lies between the container on top and a pallet system below, the pallet allowing ease of lifting and transport.

Preferably the heating pad may be held against one or more sides and top of the container.

Preferably a thermal control device within the encapsulation controls the energisation of the heating cable.

In another aspect the present invention consists in a method of manufacture of a heating pad for location at least against at least one external surface of a container to apply thermal energy to the container when connected to an electrical source, comprising or including the steps of,
providing a foamed resilient substrate with an first presenting major surface substantially equal in plan area to the underside of the container,
locating a heating cable on the first presenting major surface to form an electrical circuit that when energised provides the thermal energy,
   surrounding the substrate and heating cable with a planar sheet material above the first presenting major surface, and below a second presenting major surface of the substrate, the planar sheet material extending past the major surfaces,
sealing the planar sheet material at a periphery to form an encapsulation of the substrate, and the heating cable,
   providing an electrical connection from the heating cable internally of the encapsulation to external of the encapsulation,
such that the substrate, heating cable and in part the electrical connection are sealed from the environment external to the planar sheet material to provide a heating pad that when needed is connected to a source of electricity to supply heat to the container and any material contained therein.

Preferably the method includes the step of forming a pathway in the planar substrate on the first presenting major surface as a recess into the planar substrate.

Preferably the method includes the step of locating the heating cable into the recess.

Preferably the pathway is the same shape as the path of the electrical circuit of the heating cable.

Preferably the method includes the step of passing an electrical power cord connected to the heating cable, in part forms the electrical connection, from within the periphery, to external of the periphery prior to the sealing thereof.

Preferably the method includes the step of physically connecting the electrical power cord to at least a part of the heating pad such that it can also be used as a handle to manoeuvre at least the heating pad without pulling out from the heating pad or affecting the connection to the heating cable.

Preferably the connection is by at least one anchor to the planar substrate, directly or indirectly.

Preferably the method includes the step where the seal at the periphery lies between the first presenting major surface, and the second presenting major surface.

Preferably the seal is achieved by bonding, welding, or gluing the sheet material.

Preferably the sheet material is flexible.

Preferably the sheet material is a plastics coated woven material.

Preferably the materials for the planar substrate and planar sheet are chosen such that their thermal dissipation rate is greater than the thermal input rate of the heating cable when energised.

Preferably the heating pad once formed by the method can flex in and out of plane of the major surfaces without breaking.

Preferably the planar substrate can deform at least in part to contour to the side of the container.

Preferably the container is an intermediate bulk container (IBC).

Preferably the heating pad is located between the container on top and a pallet below, the pallet allowing ease of lifting and transport.

Preferably the heating pad may be held against one or more sides and top of the container.

Preferably the method includes the step of locating and electrically connecting a thermal control device within the encapsulation to control the energisation of the heating cable.

In another aspect the present invention consists in a container in combination with a heating pad against at least one external surface of the container, the heating pad comprising or including,
a foamed resilient substrate with a first presenting major surface substantially equal in area to the at least one surface of the container,
a heating cable located on the first presenting major surface to form an electrical circuit that when energised provides the thermal energy,
a planar sheet material above the first presenting major surface, and below a second presenting major surface of the substrate, the planar sheet material extending past the major surfaces and sealed at a periphery to form an encapsulation of the substrate and heating cable,
an electrical connection from the heating cable internally of the encapsulation to external of the encapsulation,
such that the heating pad can be located against the external surface of the container to move with that container, and when needed connected to a source of electricity can supply thermal energy to the container and any material contained therein.

In yet another aspect the present invention consists in a heating pad as described herein with reference to any one or more of the accompanying drawings.

In yet another aspect the present invention consists in a method of manufacture as described herein with reference to any one or more of the accompanying drawings.

In yet another aspect the present invention consists in a container in combination with a heating pad against at least one surface of the container as described herein with reference to any one or more of the accompanying drawings.

As used herein the term “and/or” means “and” or “or”, or both.

As used herein “(s)” following a noun means the plural and/or singular forms of the noun.

The term “comprising” as used in this specification means “consisting at least in part of”. When interpreting statements in this specification which include that term, the features, prefaced by that term in each statement, all need to be present, but other features can also be present. Related terms such as “comprise” and “comprised” are to be interpreted in the same manner.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7).

The entire disclosures of all applications, patents and publications, cited above and below, if any, are hereby incorporated by reference.

This invention may also be said broadly to consist in the parts, elements and features referred to or indicated in the specification of the application, individually or collectively, and any or all combinations of any two or more of said parts, elements and features, and where specific integers are mentioned herein which have known equivalents in the art to which this invention relates, such known equivalents are deemed to be incorporated herein as if individually set forth.

Other aspects of the invention may become apparent from the following description which is given by way of example only and with reference to the accompanying drawings.

### BRIEF DESCRIPTION OF THE DRAWINGS

Preferred forms of the present invention will now be described with reference to the accompanying drawings in which;

FIG. 1 shows an exploded view of an intermediate bulk container, heating pad of the present invention, and pallet for the heating pad and container to rest on,

FIG. 2 shows a side view of the arrangement of FIG. 1,

FIG. 3 shows a cut away view in plan of the heating pad in accordance with the present invention,

FIG. 4 shows a vertical partial cross section of the heating pad from FIG. 3 in isometric form,

FIG. 5 shows an exploded view of FIG. 4, and

FIG. 6 shows an end view of the detail from FIG. 4.

### DETAILED DESCRIPTION OF THE PREFERRED EMBODIMENT

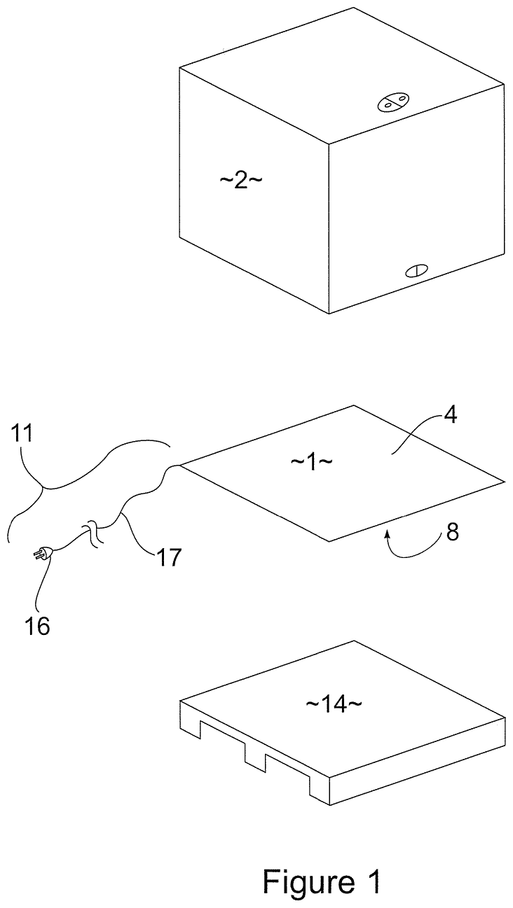

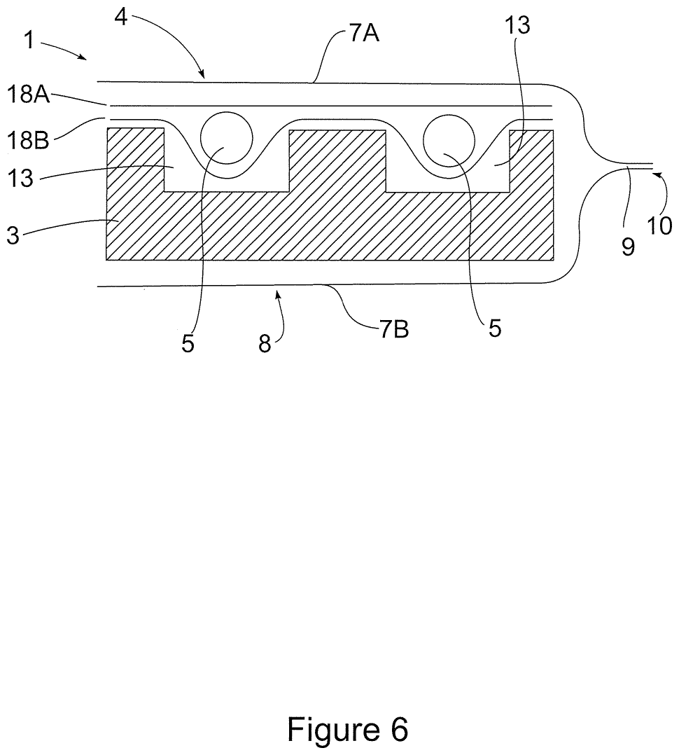

Preferred embodiments will now be described with reference to FIGS. 1 through 6.

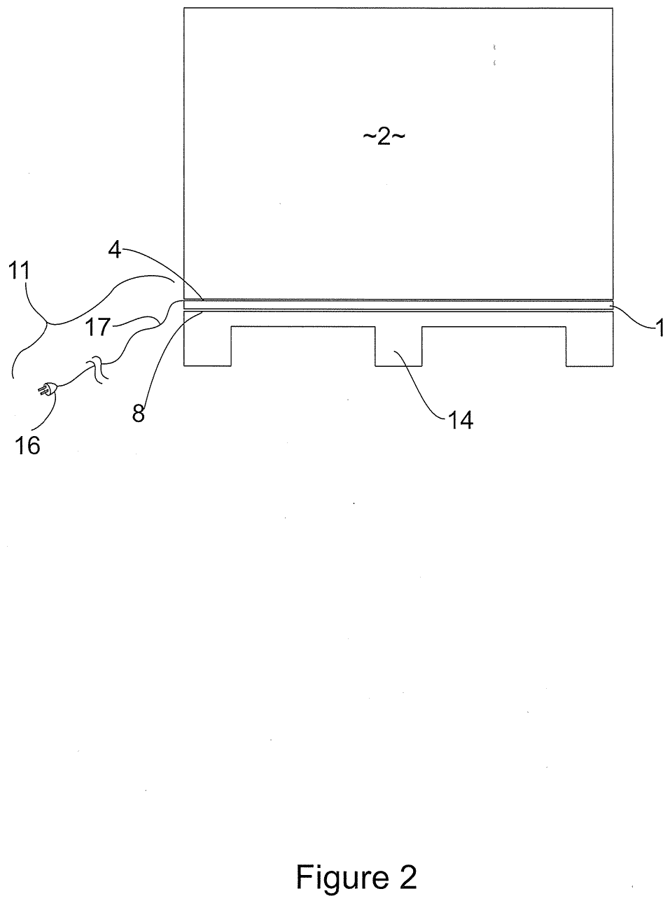

The general shape of one form of the heating pad 1, when located under a container 2 and above a pallet 14, is shown in FIGS. 1 and 2. It should be understood that when the term container is used, it means a rigid container within which the bulk product is contained, as well as a flexible container, such as a liner bag, plastic or otherwise, which is then contained in a frame or similar to restrain it. The heating pad 1 in this case will sit against the flexible container, between it and any restraining frame, secondary container, or similar.

In the embodiment shown the heating pad 1 is substantially the same plan area as the underside of the container 2. The container 2 could be rigid, semi-rigid or flexible, for example a bag with a supporting structure for the container. The heater is normally inside the supporting structure against the container 2(whether rigid, semi-rigid or flexible). This ensures uniform heating of the container 2 and its contents. In some embodiments it is sufficient to heat only the underside of the container 2 due to the rate of heating, and that once a thermal current is present then the lowest part of the container typically has the coolest material. Therefore, from an efficiency of heating aspect, and to not overheat the material this makes sense. However, in other embodiments the heating pad 1 may be located on other surfaces, for example the top or side, or may be on more than one side, and in some embodiments may be located on all sides, top and bottom. This works easily when the container 1 is an intermediate bulk container of parallel or planar sides. However the container 1 may also be cylindrical or other shape. In all these use scenarios the heating pad 1 may be formed to cover the area desired and conform to its shape. For example where the container 2 is cylindrical then the heating pad 1 may be shaped to conform to the curved sides, and also have a circular component to cover the top and or bottom. When the heating pad is located on a side or other surface of the container where it is not held in place by gravity, for example on the top or bottom of the container, then straps or other methods known in the art may be used to hold the heating pad to the required amount against the container.

In the embodiments where there are two or more heating pads 1, these are connected to each other to heat the container 2 at the same time, and they may have a controller within them to allow control of the supply of the thermal energy. Alternatively the heating pads 1 may each be connected to a separate, or linked external controller (not shown), to control their energisation and thermal energy application. Such control may simply be energisation without feedback, or may feedback the temperature, whether a proportional feedback from inside the heating pad, or by on off energisation control from within the heat pad.

The general features of the heating pad 1 are visible also in FIGS. 1 and 2, as is the electrical connection 11, in this case as a plug 16 which terminates a length of electrical power cord 17. The heating pad 1 has a periphery 10 and the electrical connection 11, via the electrical power cord 17 passes from external of the periphery 10 and the external environment to internally of the periphery 10. The heating pad 1 has a first external surface 20 and a second external surface 21. In the embodiment shown these are substantially planar in form, and in the orientation shown the first external surface 20 is upwardly presenting and is the face that locates against the surface of the container, and the second external surface 21 is lowermost presenting, and is the face that locates, for example against the pallet 14. As discussed surfaces 20 and 21 could for example be curved or similar to match the contours of the container 1 to be thermally controlled normally heating, but in some embodiments it may be cooling for example by using the thermoelectric or Peltier effect, so it is to be understood that thermal energy could be addition of energy to heat the material, or removal of thermal energy to cool the material.

The container 1 normally is of a standardised size, for example an intermediate bulk container 1 is normally a cubic metre. As such there is sufficient mass to form a high pressure between the underside (in this case) of the container 1 and the upward presenting major surface 4 of the heating pad 1 and the heating cable 5. Application of pressure reduces the thermal resistance across the interfaces between the heating cable 5, thermal spreading layers 18, sheet material 7A and the container 1.

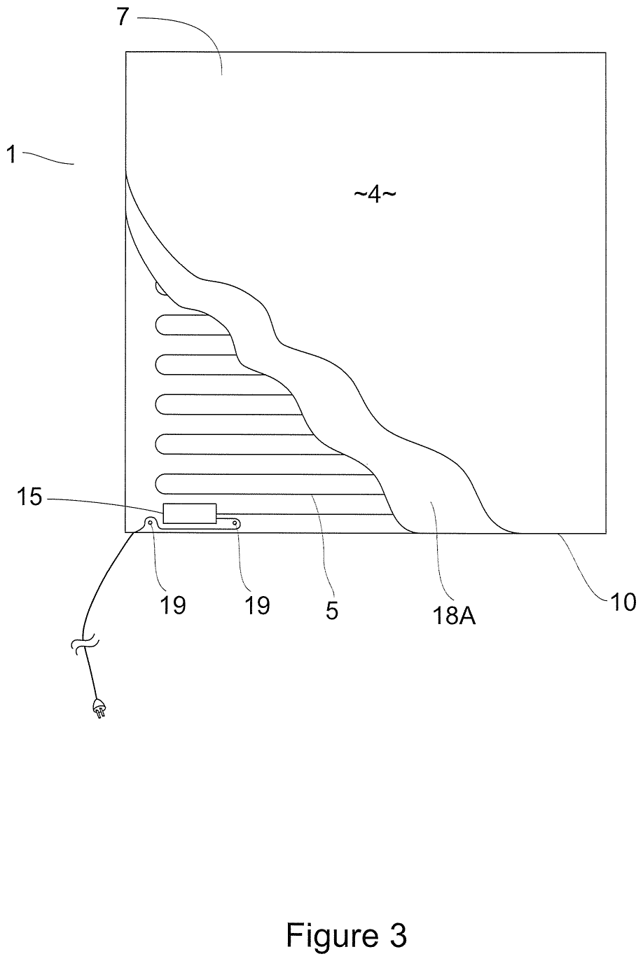

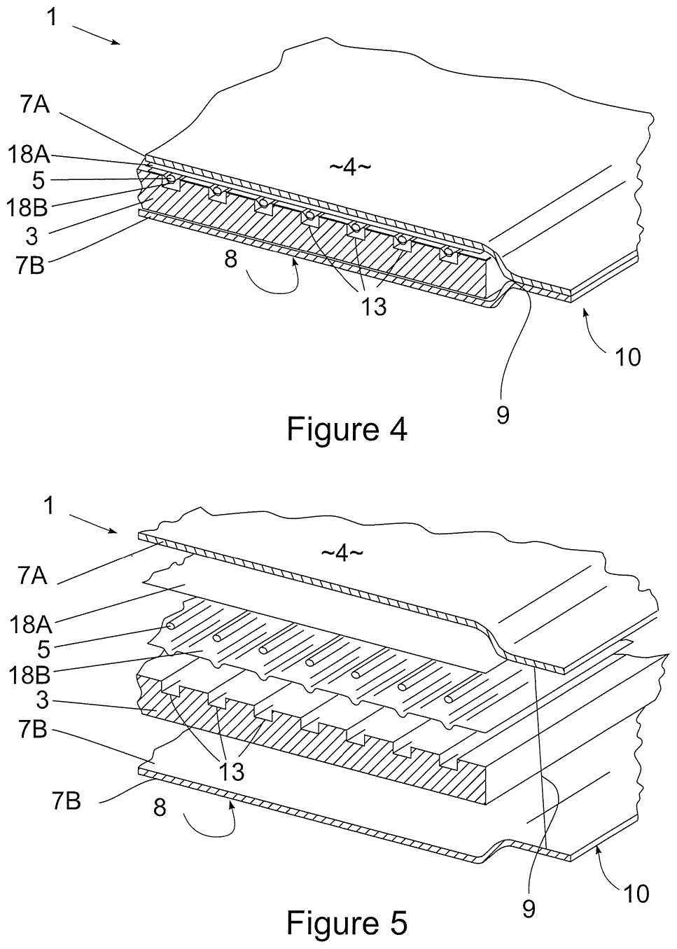

The internal components of the heating pad 1 are visible in FIG. 3 which is a plan cut-away view. The external layers are formed from a thin flexible sheet material 7 which has a seal 9 (visible in FIG. 4-6) at the periphery 10. Preferably the sheet material is in the range of 0.2 mm to 3 mm thick, and ideally is in the range of 1 mm to 2 mm thick. The sheet material 7 is flexible and preferably airproof, and preferably waterproof, and preferably foodsafe. The sheet material 7 is also preferably inert and un-reactive with the agents and environments it typically comes into contact with, for example gasses and liquids. Further the sheet material preferably keeps these properties over a wide range, or the range, of temperatures the heating pad is expected to encounter. As an example the sheet material may be a woven material which is then plastic material coated, such that it is flexible strong, waterproof, airproof, foodsafe and inert.

The sheet material 7 preferably is capable of being sealed to itself, to, for example form the seal 9 at the periphery 10. Such a seal may be achieved by high frequency sonic welding, bonding, adhesives, gluing or thermally or other techniques known in the art for joining such materials. In the preferred form as shown in FIGS. 4-6 the seal lies between the upper most surface of the upper sheet material 7A, and lower most surface of the lower sheet material 7B, and preferably lies between the first presenting major surface 4 and the second presenting major surface 8.

Underneath the sheet material 7 is, in the preferred embodiment, an upper thermal spreading layer 18A. This material performs the function of dissipating the heat from the heating cable 5 across a greater area, and then passes it to the underside of the upper sheet material 7A, to at least in part help avoid hotspots. In other embodiments the heating cable may be replaced with an equivalent element, such as those known in the art, for example a printed or etched circuit, carbon fabric element and other equivalents known in the art.

Any material that performs a thermal spreading function may be used for 18A and 18B, and in the preferred embodiment this is a metallised foil, for example aluminium, or aluminium alloy foil. Any material that is malleable or that otherwise can conform to the heating cable 5, the substrate below and sheet material above to reduce the thermal resistance can be used.

Below the upper thermal spreading layer 18A is a heating cable 5. This is laid out in a desired pattern to form an electrical circuit. In the form shown, the heating cable 5 runs in long parallel runs up and down the length, or across the width of the heating pad. The exact layout pattern will vary as desired for the shape of heating pad, for example it may take a circular form when the heating pad is circular, the path will also take account of any bending that may occur, for example when applied to a curved surface, to put the least strain on the heating cable.

Below the heating cable 5, is a lower thermal spreading layer 18B, again to perform a similar function as 18A. The two layers 18A and 18B may just be laid in place, or may be sealed at their periphery's, or in addition between the cables, to hold the heating cable 5 in place, and/or to provide additional functionality such as water proofing or similar. The malleability of the layers 18A and 18B will allow them to deform about the heating cable 5 to increase thermal conductivity, and to hold the cable 5 in place.

Below the lower thermal spreading layer 18B is a planar substrate 3. The substrate is preferably within the range of 2 mm to 20 mm thick, and ideally is within the range of 5 mm to 15 mm thick. This has the function of imparting a majority of the shape retention, whether planar, curved or otherwise, to the heating pad 1. In the preferred the planar substrate is stiff but may bend or flex as needed, and may also be locally deformable. In other forms the substrate 3 may be bend out of plane, for example to form a cylinder for applying heat to a drum or other curved container. What ever form, planar, curved or otherwise, the substrate, and thus the heating pad is formed into, it is also resilient to allow bending as needed. For example the pallet that a heating pad 1 is located on may warp or bend, likewise a curved heating pad may need to be opened up to apply or remove it from a curved container such as a drum. In these situations the substrate and resulting heating pad 1 are sufficiently resilient to allow such bending without failure of permanent deformation. Such deformation may also be due in some part to handling, for example sliding over an uneven surface. It is desirable that that heating pad in this case does not fail, but is resilient to deal with such deformation. The heating pad may allow deformation between 0 mm to 100 mm over a 1 m width of heating pad, and ideally the heating pad will only suffer between 1 mm to 30 mm out of plane bending. Similar figures apply for a curved heating pad.

The substrate, and resulting heating pad 1 can also deform or dent by local compression. Ideally such compression is not permanent and is recoverably after removal of the force, for example the load of the container, is removed.

This local and global deformation resilience allows the resultant heating pad 1 to contour to the container 1 and, for example to the pallet 14 it is sandwiched between for example if the container has local deformations for example from manufacture or subsequent handling. It also gives the heating pad 1 resilience when being handled, stored and shipped, for example is the container, or pallet or similar has a gross deformation, for example it is bent or otherwise deformed over its width or length. Further, being locally deformable, will allow it to dent and thus reduce or prevent damage to the heating cable 5, where otherwise such an impact would sever or similar, the heating cable 5. In doing so the planar substrate 3 acts to protect the heating cable 5 and helps to prevent damage to it or breakage.

In the preferred form the planar substrate also has high thermal resistance. This helps it to prevent wastage of thermal energy to and through the lower presenting major surface 8, which in turn helps the efficiency of the pad 1 and drives the thermal energy into the container 1. In the preferred form the planar substrate is a foamed material, ideally closed cell, such as a high density polyurethane foam or similar. The planar substrate 3 may be cast in the particular form as needed, or may be heated and then formed, and/or may be machined as desired.

There is only a substrate below the heating cable, there is no substrate located above the heating cable. This results in a thin heating pad that reflects the thermal energy upwards and there is little blocking transmission of the thermal energy from the heating cable to the container and material therein.

Shown in FIG. 4 and in particular in 5, the planar substrate 3 has pre-formed recesses 13 as a series of connected radial or parallel grooves in its upper or first presenting major surface 4. These are to receive the lower thermal spreading layer 18B and in particular the heating cable 5. As they are connected they act as a guide for placing the heating cable during manufacture, and in use provide a permanent relief for the heating cable into the substrate, and reduce the load on the heating cable. In the preferred form the recesses 13 follow the pathway 12 of the heating cable 5. This provides further protection for the cable, and also reduces the localised pressure on the cable, planar substrate and upper sheet material 7A when in use. The result is a reduction in hot spots and also the chance of breakage of the heating cable 5 and or its rubbing through the upper sheet material 7A. The recesses may be moulded or machined into the substrate.

In the preferred form the materials for the planar substrate, thermal spreading layer and sheet material are chosen such that their thermal dissipation or thermal capacity, taking into account also the resistance of the thermal interfaces between each layer, is greater than the thermal input or output rate from the heater cable 5 when energised, this prevents the creation of hotspots and therefore reduces the chance of early degradation or failure of the heating pad or its components. Ensuring there are no, or few hotspots will prevent damage to thermally sensitive material contained in the container.

The electrical power cord 17 is also anchored to the planar substrate 3. This can be achieved by one or more physical connections 19 between the electrical power cord 17 and the substrate, and may for example involve winding the electrical power cord through a labyrinth to further increase the anchoring. The result, when all assembled is the electrical power cord 17 is securely attached to the heating pad 1 and reduces the likelihood of it be pulled out or otherwise threatening the integrity of the electrical circuit 6. The electrical power cord then also forms a handle for manoeuvring of at least the heating pad 1 itself

When manufacturing the heating pad 1, the planar substrate 3 with its recess pathway 13 for the thermal cable 5 is presented and the lower thermal spreading layer 18B is laid over the top of the planar substrate 1. The heating cable 5 is then laid on top and into or above the recesses 13. The heating cable is then connected to any thermal control device 15 (optional) and that in turn is connected to the electrical power cord 17 to thus form the electrical circuit 6. The top thermal spreading layer 18A is then laid over the top. In other forms there may be a subassembly of the heating cable 5 already sandwiched between the bottom and top thermal spreading layers 18B and 18A. The resulting assembly then has the upper and lower sheet materials 7A and 7B located about it and the periphery 10 is then sealed to form the seal 9. Any plug needed is also connected to the electrical power cord 17.

The foregoing description of the invention includes preferred forms thereof. Modifications may be made thereto without departing from the scope of the invention.

1. A heating pad for a container to lie against at least one external surface of the container, and apply thermal energy to the container, and any material therein, when needed, comprising or including,
a foamed resilient substrate with a first presenting major surface substantially equal in area to the at least one external surface of the container,
a heating cable located on the first presenting major surface to form an electrical circuit that when energised provides the thermal energy,
a planar sheet material above the first presenting major surface, and below a second presenting major surface of the substrate, the planar sheet material extending past the first and second presenting major surfaces and sealed at a periphery to form an encapsulation of the substrate and heating cable, wherein the planar substrate has a pathway formed on the first presenting major surface as a recess into the planar substrate to receive the heating cable,
an electrical connection from the heating cable internally of the encapsulation to external of the encapsulation,
such that the heating pad can be located against the at least one external surface of the container to move with that container, and when connected to a source of electricity can supply thermal energy to the container and any material contained therein.

2. The heating pad according to claim 1 wherein the resilient substrate is planar or curved when manufactured to match the contour of the container.

3. (canceled)

4. The heating pad as claimed in claim 1 wherein the pathway is a series of preformed connected radial or parallel grooves.

5. The heating pad as claimed in claim 1 wherein a thermal output of the heater cable is below a thermal capacity of the planar substrate and planar sheet material to prevent it from burning.

6. The heating pad as claimed in claim 1 wherein the planar substrate and planar sheet material have a thermal dissipation rate that is greater than the thermal output rate of the heating cable when energised.

7. The heating pad as claimed in claim 1 wherein the second presenting major surface is parallel to the first major presenting surface.

8.-9. (canceled)

10. The heating pad as claimed in claim 1 wherein the electrical connection is also physically connected to the planar substrate or planar sheet material such that it can also be used as a handle to manoeuvre at least the heating pad without pulling out from the heating pad or affecting the connection to the heating cable.

11. The heating pad as claimed in claim 1 wherein the seal at the periphery lies substantially between the first presenting major surface, and the second presenting major surface.

12.-14. (canceled)

15. The heating pad as claimed in claim 1 wherein the heating pad can flex in and out of plane of the major surfaces without breaking.

16. The heating pad as claimed in claim 1 wherein the planar substrate can deform at least in part to contour to the underside of the container to improve transfer of the thermal energy.

17. The heating pad as claimed in claim 1 wherein the container is an intermediate bulk container (IBC), or drum.

18. The heating pad as claimed in claim 1 wherein the heating pad lies between the container on top and a pallet system below, the pallet allowing ease of lifting and transport.

19. The heating pad as claimed in claim 1 wherein the heating pad may be held against one or more sides and top of the container.

20. The heating pad as claimed in claim 1 wherein a thermal control device within the encapsulation controls the energisation of the heating cable.

21. A method of manufacture of a heating pad for location at least against at least one external surface of a container to apply thermal energy to the container when connected to an electrical source, comprising or including the steps of,
providing a foamed resilient substrate with an first presenting major surface substantially equal in plan area to the underside of the container,
forming a pathway in the planar substrate on the first presenting major surface as a recess into the planar substrate,
locating a heating cable on the first presenting major surface to form an electrical circuit that when energised provides the thermal energy,
surrounding the substrate and heating cable with a planar sheet material above the first presenting major surface, and below a second presenting major surface of the substrate, the planar sheet material extending past the major surfaces,
sealing the planar sheet material at a periphery to form an encapsulation of the substrate, and the heating cable,
providing an electrical connection from the heating cable internally of the encapsulation to external of the encapsulation,
such that the substrate, heating cable and in part the electrical connection are sealed from the environment external to the planar sheet material to provide a heating pad that when needed is connected to a source of electricity to supply heat to the container and any material contained therein.

22.-24. (canceled)

25. The method as claimed in claim 15 including the step of physically connecting the electrical power cord to at least a part of the heating pad such that it can also be used as a handle to manoeuvre at least the heating pad without pulling out from the heating pad or affecting the connection to the heating cable.

26. The method as claimed in claim 15 including where the connection is by at least one anchor to the planar substrate, directly or indirectly.

27. The method as claimed in claim 15 including the step where the seal at the periphery lies between the first presenting major surface, and the second presenting major surface.

28.-36. (canceled)

37. The method as claimed in claim 15 including the step of locating and electrically connecting a thermal control device within the encapsulation to control the energisation of the heating cable.

38. A container in combination with a heating pad against at least one external surface of the container, the heating pad comprising or including,
a foamed resilient substrate with a first presenting major surface substantially equal in area to the at least one surface of the container, the foamed resilient substrate having a pathway in the planar substrate on the first presenting major surface as a recess into the planar substrate,
a heating cable located on the first presenting major surface to form an electrical circuit that when energised provides the thermal energy,
a planar sheet material above the first presenting major surface, and below a second presenting major surface of the substrate, the planar sheet material extending past the major surfaces and sealed at a periphery to form an encapsulation of the substrate and heating cable,
an electrical connection from the heating cable internally of the encapsulation to external of the encapsulation,
such that the heating pad can be located against the external surface of the container to move with that container, and when needed connected to a source of electricity can supply thermal energy to the container and any material contained therein.
